(19) United States
(12) Patent Application Publication
(10) Pub. No.: US 2016/0210324 A1
(43) Pub. Date: Jul. 21, 2016

(54) FLEXIBLE DATA FORMAT FOR DATABASE MANAGEMENT SYSTEMS

(71) Applicant: HEWLETT PACKARD ENTERPRISE DEVELOPMENT LP, Houston, TX (US)

(72) Inventor: Sathyanarayanan Manamohan, Bangalore (IN)

(73) Assignee: HEWLETT PACKARD ENTERPISE DEVELOPMENT LP, Houston, TX (US)

(21) Appl. No.: 14/916,530

(22) PCT Filed: Sep. 25, 2013
(86) PCT No.: PCT/US2013/061686

§ 371 Date: Mar. 3, 2016

(51) Int. Cl. G06F 17/30

(52) U.S. Cl. CPC G06F 17/30368; G06F 17/30466; G06F 17/30359

(57) ABSTRACT

Example embodiments relate to providing a flexible data format for database management systems. In example embodiments, a query command to access a plastic table in a database is received, where the plastic table is a combination of at least two component sub-tables. The query command is executed to join the component sub-tables in the plastic table by using an AScan operator to obtain datarows from each of the component sub-tables, where the AScan operator converts an end of file (EOF) value to a null datarow that comprises null values, and joining the datarows obtained from the AScan operator to create query results for the query command.

### BACKGROUND

NoSQL systems are flexible storage systems that are well suited for storing the variety of data captured in large datasets. A reason for the popularity of NoSQL systems is their ability to encapsulate information inside flexible user defined objects as opposed to a relation database management system (RDBMS), which imposes a strict structure on stored information. Key-value stores provide an efficient means to represent and store objects with a large number of attributes. Such systems provide the ability to add or remove attributes to objects on demand as a related application evolves. Though the number of attributes is usually large, a given object will usually have values only for a few of these attributes while the rest are not present. Various techniques have been implemented to emulate these characteristics in traditional relational database management systems.

### BRIEF DESCRIPTION OF THE DRAWINGS

The following detailed description references the drawings, wherein:

FIG. 1 is a block diagram of an example computing device for providing a flexible data format for a database management system (DBMS);

FIG. 2 is a block diagram of an example computing device in communication with applications for providing a flexible data format for a DBMS;

FIG. 3 is a flowchart of an example method for execution by a computing device for providing a flexible data format for a DBMS;

FIG. 4 is a flowchart of an example method for execution by a computing device for accessing data records in a plastic table;

FIG. 5 is a flowchart of an example method for execution by a computing device for modifying the schema of a plastic table;

FIG. 6A is a diagram of an example plastic table;

FIG. 6B is a diagram of an example component table;

FIGS. 7A-7D are diagrams of example query execution plans for a plastic table; and

FIG. 7E is an example workflow for performing an alter operation on a plastic table.

### DETAILED DESCRIPTION

As detailed above, DBMS's are beginning to move towards NoSQL features such as flexible user defined objects. Flexible user defined objects help enhance the plasticity (i.e., the ability to add and remove columns as the application evolves) of traditional DBMS's, which have a rigid, normalized row structure to represent data elements. Further, flexible user defined objects may allow for sparse data columns (i.e., most of the attributes in the object are not specified resulting in a table having long rows with many null columns) to be stored more efficiently. Null values create undesirable overhead when a datarow is processed and stored in the DBMS.

Example embodiments disclosed herein provide predicting execution times of concurrent queries. For example, in some embodiments, a query command to access a plastic table in a database is received, where the plastic table is a combination of at least two component sub-tables. The query command is executed to join the component sub-tables in the plastic table by using an AScan operator to obtain datarows from each of the component sub-tables, where the AScan operator converts an end of file (EOF) value to a null datarow that comprises null values, and joining the datarows obtained from the AScan operator to create query results for the query command.

In this manner, example embodiments disclosed herein provide a flexible data format for a DBMS by using component sub-tables and modified operators. Specifically, an AScan operator may be provided that preprocesses datarows from component sub-tables, which are capable of storing the datarows in a more flexible manner.

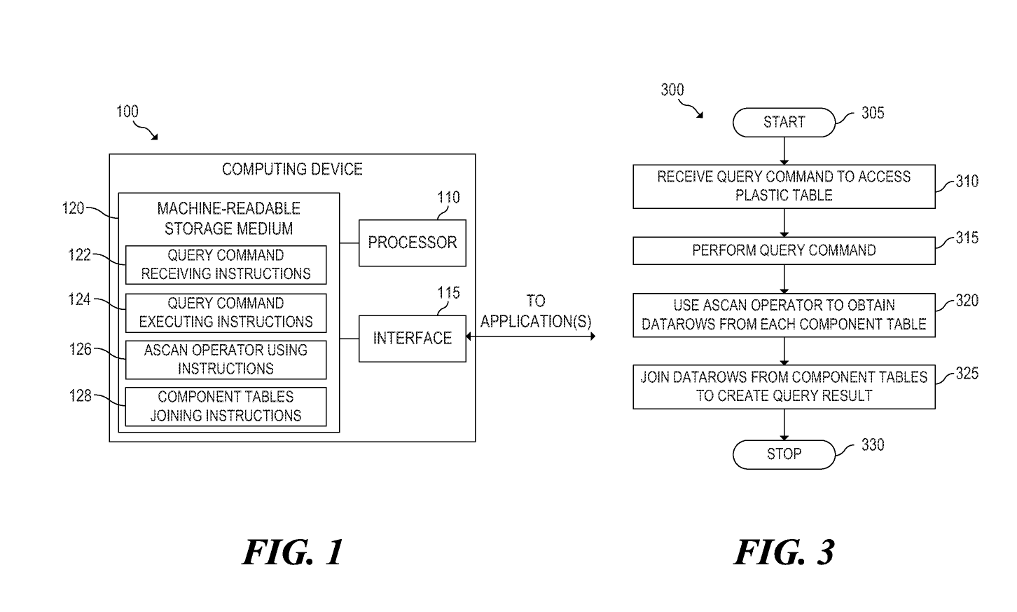

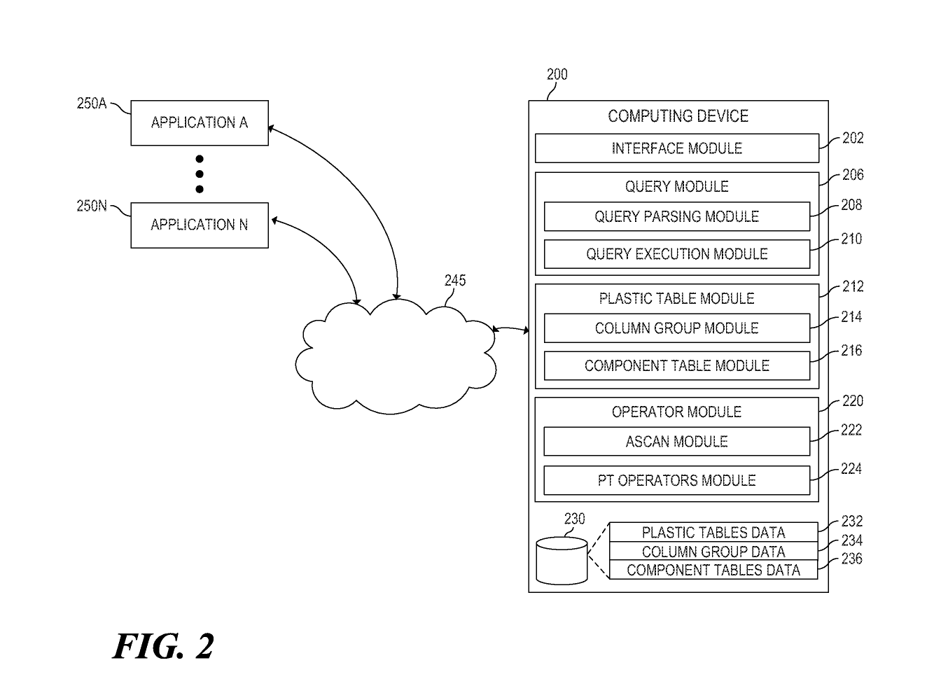

Referring now to the drawings, FIG. 1 is a block diagram of an example computing device 100 for providing a flexible data format for a DBMS. Computing device 100 may be any computing device (e.g., database server, desktop computer, laptop computer, tablet device, etc.) that is accessible by applications, such as application A 250A and application N 250N of FIG. 2. In the embodiment of FIG. 1, computing device 100 includes a processor 110, an interface 115, and a machine-readable storage medium 120.

Processor 110 may be one or more central processing units (CPUs), microprocessors, and/or other hardware devices suitable for retrieval and execution of instructions stored in a non-transitory, machine-readable storage medium 120. Processor 110 may fetch, decode, and execute instructions 122, 124, 126, 128 to provide a flexible data format for a DBMS, as described below. As an alternative or in addition to retrieving and executing instructions, processor 110 may include one or more electronic circuits comprising a number of electronic components for performing the functionality of one or more of instructions 122, 124, 126, 128.

Interface 115 may include a number of electronic components for communicating with databases. For example, interface 115 may be an Ethernet interface, a Universal Serial Bus (USB) interface, an IEEE 1394 (Firewire) interface, an external Serial Advanced Technology Attachment (eSATA) interface, or any other physical connection interface suitable for communication with the applications. Alternatively, interface 115 may be a wireless interface, such as a wireless local area network (WLAN) interface or a near-field communication (NFC) interface. In operator, as detailed below, interface 115 may be used to send and receive data, such as plastic tables data and column group data, to and from a corresponding interface of an application.

Machine-readable storage medium 120 may be any non-transitory electronic, magnetic, optical, or other physical storage device that stores executable instructions. Thus, machine-readable storage medium 120 may be, for example, Random Access Memory (RAM), non-volatile RAM, an Electrically-Erasable Programmable Read-Only Memory (EEPROM), a storage drive, an optical disc, and the like. As described in detail below, machine-readable storage medium 120 may be encoded with executable instructions for providing a flexible data format for a DBMS.

Query command receiving instructions 122 processes query commands for accessing plastic tables in a database. For example, query command receiving instructions 122 may be incorporated in a DBMS that manages data in the database. In this example, query commands may be processed to retrieve data records from the database. Specifically, a query command may be analyzed to generate a query plan, which is then executed to access data records in the database. The query plan may include a reference to a plastic table in the database, where a plastic table is a combination of component sub-tables. A query plan is an ordered set of steps describing a structured query language (SQL) statement for accessing a DBMS and typically depicted in a hierarchical tree. The query plan may include query features that include, but are not limited to, a set of query operators, an amount of data for processing, etc.

Query command executing instructions 124 executes the query plan generated as described above. Specifically, the operators in the query plan may be used to obtain datarows from the database. For example, various scan operators may be used as described below to obtain datarows from a plastic table for a range of keys.

AScan operator performing instructions 126 uses AScan operators according to the generated query plans. A scan operator reads datarows into the query plan to make the datarows available for further processing. The AScan operator is a modified scan operator that automatically process component sub-tables so that the datarows obtained can be combined in a corresponding plastic table. Specifically, the AScan operator may pre-process datarows from component sub-tables to identify null datarows. In this case, a null datarow is a datarow that has a null value in each of its data columns, where the null datarow may be identified by the AScan operator as an end of file (EOF) value. The EOF value allows the null datarow to be stored in a component sub-table without storing physical nulls in the database.

Component tables joining instructions 128 joins datarows from component sub-tables to create datarows for a corresponding plastic table. The datarows from the component sub-tables may be joined according to the query plan. For example, a PTScan operator may iteratively perform AScans of the component sub-tables for each key in a range of keys. In this example, the PTScan operator interprets a null datarow from a component sub-table as having all null column values when combining with non-null data values from an associated component sub-table. When null datarows are returned from all AScan operators being performed for the PTScan operator, the range scan is considered complete.

FIG. 2 is a block diagram of an example computing device 200 in communication via a network 245 with applications (e.g., application A 250A, application N 250N). As illustrated in FIG. 2 and described below, computing device 200 may communicate with applications to provide a flexible data format for a DBMS.

As illustrated, computing device 200 may include a number of modules 202-224. Each of the modules may include a series of instructions encoded on a machine-readable storage medium and executable by a processor of the computing device 200. In addition or as an alternative, each module may include one or more hardware devices including electronic circuitry for implementing the functionality described below.

As with computing device 100 of FIG. 1, computing device 200 may be a server, a notebook, desktop, tablet, workstation, mobile device, or any other device suitable for executing the functionality described below. As detailed below, computing device 200 may include a series of modules 202-224 for providing a flexible data format for a DBMS.

Interface module 202 may manage communications with the applications (e.g., application A 250A, application N 250N). Specifically, the interface module 202 may (1) initiate connections with the applications and then send or receive query data to/from the applications.

Query module 206 may manage queries for the applications (e.g., application A 250A, application N 250N). Although the components of query module 206 are described in detail below, additional details regarding an example implementation of module 206 are provided above in connection with instructions 122 and 124 of FIG. 1.

Query parsing module 208 may parse query commands received from the applications (e.g., application A 250A, application N 250N). Specifically, query parsing module 208 may parse a SQL statement in the query command to generate a query plan. For example, the query plan may include nodes for operators in the SQL statement that are arranged in a hierarchical tree. In this example, the query plan is used to perform the requested query command to retrieve or modify data stored in storage device 230.

Query execution module 210 may execute the query plan generated by query parsing module 208. For example, the query plan may be traversed so that each operator in the plan is performed. In this example, query execution module 210 may use operator module 220 to perform the operators (e.g., AScan operator, PTScan operator, PTInsert operator, PTDelete operator, etc.). Query execution module 210 may also combine the results of the operators for providing to the requesting application (e.g., application A 250A, application N 250N).

Plastic table module 212 may manage plastic tables stored in storage device 230. Although the components of plastic table module 212 are described in detail below, additional details regarding an example implementation of module 212 are provided above in connection with instructions 128 of FIG. 1.

Column group module 214 may manage column groups for component sub-tables. Specifically, column group module 214 may select column groups from the columns of a plastic table based on various requirements (e.g., application performance requirements, sparse column groupings, etc.), where column groups are stored as column group data 234 in storage device 230. In some cases, column groups may be modified dynamically for plastic tables that are in production. In this case, the column groups of a plastic table may be periodically rebalanced based on the current data stored in the plastic table (e.g., adjust column groups based on statistical data related to null values in the plastic table to group sparse columns).

Component table module 216 may manage component sub-tables for the plastic tables in storage device 230. Component table module 216 may maintain relationships between plastic tables and component sub-tables. For example, a lookup table describing the relationships between plastic tables and component sub-tables may he maintained as component tables data 236 in storage device 230. Component table module 216 may be used to facilitate query plans by, for example, identifying component sub-tables that should be scanned to satisfy a select operation of a plastic table.

Operator module 220 may use operators to access plastic tables and component sub-tables stored in storage device 230. Although the components of operator module 220 are described in detail below, additional details regarding an example implementation of module 220 are provided above in connection with instructions 126 of FIG. 1.

AScan module 222 may use AScan operators to obtain datarows from component sub-tables. Specifically, an AScan operator may be executed as part of a query plan, where the AScan operator automatically handles null datarows retrieved from component sub-tables. For example, if the AScan operator retrieves an end of file (EOF) value from a component sub-table for a key that exists in the related plastic table, the AScan operator may automatically convert the EOF value to a null datarow (i.e., a datarow with all null values for the data columns). AScan module 222 may he used by Plastic Table (PT) operations module as described below when executing a PTScan operator.

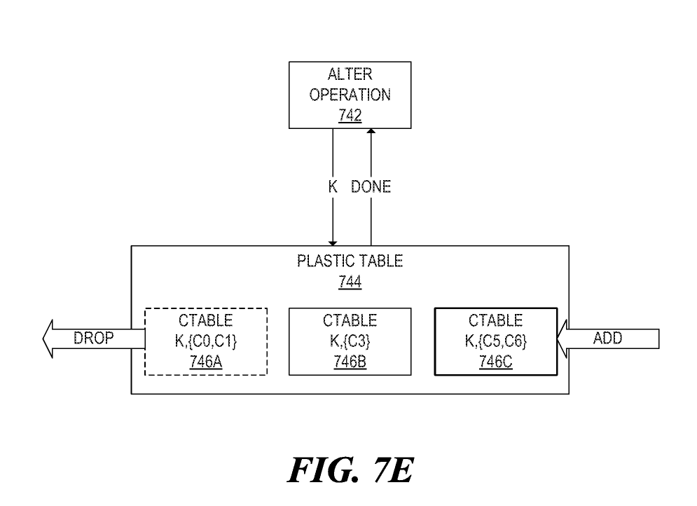

PT Operators Module 224 may execute PT operators on database entities stored in storage device 230. PT operators may include PTScan operators, PTInsert operators, PTDelete operators, etc. Example query plans including PT operators are described below with respect to FIGS. 7A-7D. For example, a PTScan operator may scan for a range of keys in a plastic table, where the query plan specifies that AScan operators should be used to scan for the range of keys in each of the related component sub-tables. In this example, the AScan operators retrieve datarows from the component sub-tables, which are joined together to form datarows for the plastic table.

Storage device 230 may be any hardware storage device for maintaining data accessible to computing device 200. For example, storage device 230 may include one or more hard disk drives, solid state drives, tape drives, and/or any other storage devices. The storage devices may be located in computing device 200 and/or in another device in communication with computing device 200. As detailed above, storage device 230 may maintain plastic tables data 232, column group data 234, and component tables data 236.

Computing device 200 may provide various database(s) accessible to applications (e.g., application A 250A, application N 250N) over the network 245 that is suitable for providing database content. Applications (e.g., application A 250A, application N 250N) may provide users with access to database content in computing device 200 such as data tables, data views, stored procedures, indexes, sequences, etc.

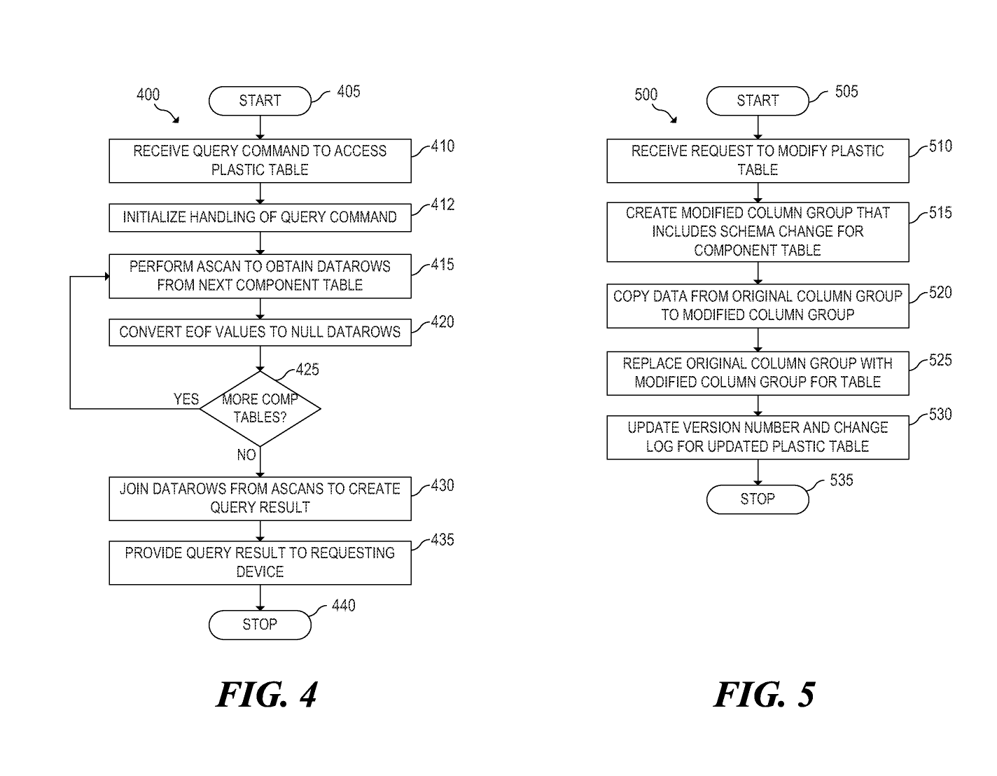

FIG. 3 is a flowchart of an example method 300 for execution by a computing device 100 for providing a flexible data format for a DBMS. Although execution of method 300 is described below with reference to computing device 100 of FIG. 1, other suitable devices for execution of method 300 may be used, such as computing device 200 of FIG. 2. Method 300 may be implemented in the form of executable instructions stored on a machine-readable storage medium, such as storage medium 120, and/or in the form of electronic circuitry.

Method 300 may start in block 305 and continue to block 310, where computing device 100 receives a query command to access a plastic table from an application. For example, the query command may request that a select operation be performed on a plastic table in the database to retrieve datarows for a range of keys. In block 315, the query command is performed by computing device 100. Specifically, a query plan may be generated for the query command and then used to perform operation(s) on data entities in the database.

As part of performing the query command in block 320, computing device 100 uses an AScan operator to obtain datarows from each component sub-table associated with the target plastic table. The AScan operator may be configured to efficiently handle null values in the plastic table. For example, a component sub-table may include columns that have a higher probability of being null so that EOF values can be used in the component sub-table to specify a null datarow. In this example, the AScan operator automatically converts EOF values to null datarows when retrieving datarows from the component sub-table. In block 325, the datarows retrieved from the component sub-tables are combined to create a query result. Specifically, the datarows from the sub-tables may be joined to create datarows for the plastic table, which are then returned to the application. Method 300 may then continue to block 330, where method 300 may stop.

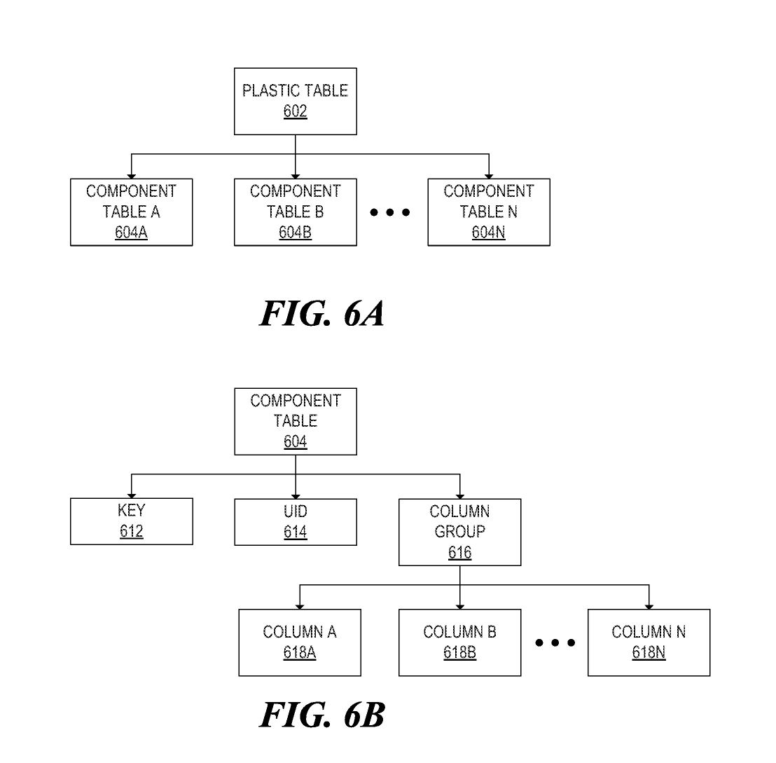

FIG. 4 is a flowchart of an example method 400 for execution by a computing device 100 for accessing data records in a plastic table. Although execution of method 400 is described below with reference to computing device 100 of FIG. 1, other suitable devices for execution of method 400 may be used, such as computing device 200 of FIG. 2. Method 400 may be implemented in the form of executable instructions stored on a machine-readable storage medium, such as storage medium 120, and/or in the form of electronic circuitry.

Method 400 may start in block 405 and continue to block 410, where computing device 100 receives a query command to access a plastic table from an application. The application may be a database-driven application provided by computing device 100 or some other server device. The query command may include a SQL statement and other parameters for handling by computing device 100. In block 412, handling of the query command is initialized. Specifically, the SQL statement in the query command is analyzed to generate a query plan, which can then be traversed to perform operations in the database. For a select operation of a plastic table, the query plan will include AScan operators that are used to access data in associated component sub-tables as described below.

In block 415 as the query plan is traversed, an AScan operator is used to obtain datarows from the next component sub-table in the query plan. The AScan operator may be a child node of a PTScan operator as described below with respect to FIG. 7A, where the PTScan is configured to join results from related AScan operators. In block 420, the AScan operator converts EOF values to null datarows as the EOF values are retrieved from the component sub-tables. Specifically, for a key value that exists in the plastic table, the AScan operator may automatically create a null datarow if an EOF value is returned for the key value when scanning a component sub-table. In this manner, null datarows may be stored in the component sub-table without using physical space in the database.

In block 425, computing device 100 determines if there are more component sub-tables to process in the query plan. If there are more component sub-tables to process, method 400 returns to block 415 to process the next component sub-table. If there are no more component sub-tables to process, the datarows retrieved by the related AScan operators are joined to create a query result in block 430. For example, the datarows from the component sub-tables may be joined based on a primary key of the related plastic table to create datarows for the plastic table. In this example, the plastic table is an abstraction that is embodied by combining the related component sub-tables. In block 435, the query result is provided to the requesting application. Method 400 may then continue to block 440, where method 400 may stop.

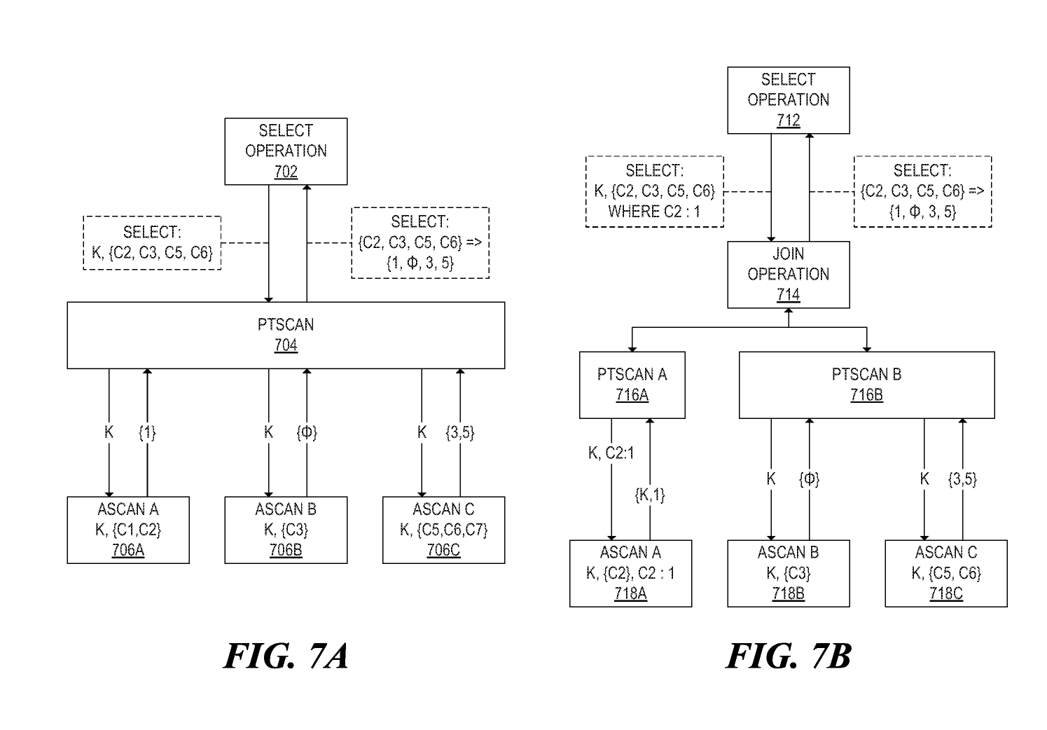

FIG. 5 is a flowchart of an example method 500 for execution by a computing device 100 for modifying the schema of a plastic table. Although execution of method 500 is described below with reference to computing device 100 of FIG. 1, other suitable devices for execution of method 500 may be used, such as computing device 200 of FIG. 2. Method 500 may be implemented in the form of executable instructions stored on a machine-readable storage medium, such as storage medium 120, and/or in the form of electronic circuitry.

In block 510, computing device 100 receives a request to modify a plastic table. Examples of requested modifications may include adding a column, removing a column, changing a column datatype, changing a primary key, etc. In block 515, a modified column group that includes the schema change is created for a related component sub-table. For example, a column group with a new column may be created to add a column to a component sub-table of the plastic table. In this example, the new column group may co-exist with an original column group of the component sub-table. Accordingly, the plastic table may continue to provide data in the database using the original column group before transitioning to the new column group.

In block 520, data is copied from the original column group of the component sub-table to the modified column group. At this stage, a lock may be placed on the component sub-table to prevent further updates before the component sub-table is able to transition to the modified column group. The lock may allow for data to be read from the component sub-table and queue any update requests until the component sub-table is transitioned. In block 525, the original column group is replaced with the modified column group in the component sub-table. For example, an entry in a lookup table may be updated to associate the component sub-table table with the modified column group. In this example, the lock placed on the component sub-table may be released after the original column group is replaced.

In block 530, a version number and change log of the plastic table is updated. Specifically, the version number may be incremented to reflect the change to the plastic table, and an entry may be created in the change log that describes the changes made to the plastic table (e.g., a new column was added to the plastic table). Method 500 may then continue to block 535, where method 500 may stop.

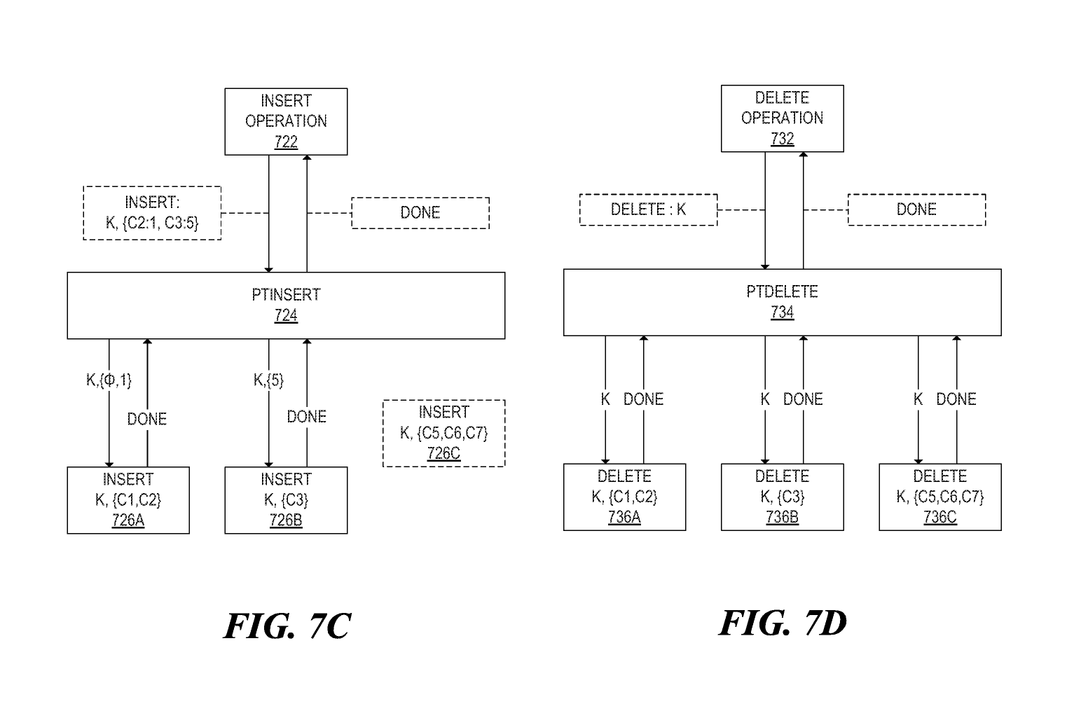

FIG. 6A is a diagram of an example plastic table 602. The plastic table 602 may be associated with any number of component sub-tables (e.g., component sub-table A 604A, component sub-table B (604B), component sub-table N 604N). For example, a database may maintain a lookup table that includes entries for each plastic table 602 and its associated component sub-tables (e.g., component sub-table A 604A, component sub-table B (604B), component sub-table N 604N).

FIG. 6B is a diagram of an example component sub-table 604. The component sub-table 604 includes a key 612, a unique identifier 614, and a column group 616. The key 612 may be the primary key of the component sub-table 604 that is used to scan for datarows. The key 612 of the component sub-table may be shared with other component sub-tables with the same parent plastic table (e.g., component sub-table A 604A, component sub-table B 604B, component sub-table N 604N of FIG. 6A may have the same key). The unique identifier 614 uniquely identifies the component sub-table 604 in the database and may be used to associate the component sub-table with plastic tables in a lookup table as described above.

Column group 616 of component sub-table 604 may include the data columns (e.g., column A 618A, column B 618B, column N 618N) that are in component sub-table 604. The column group 616 may include any number of data columns (e.g., column A 618A, column B 618B, column N 618N), which are selected to satisfy application requirements. For example, the column group 616 may be optimized to include columns (e.g., column A 618A, column B 618B, column N 618N) with a high probability of having null values (i.e., sparse columns).

FIGS. 7A-7D are diagrams of example query execution plans for a plastic table. In FIG. 7A, a query plan for a select operation 702 is shown. The select operation 702 includes a PTScan 704, where a key value K and a group of columns are provided to the PTScan 704. The PTScan 704 references three AScan operators 706A, 706B, 706C. Each of the AScan operators 706A, 706B, 706C receives the key value K and relevant columns from the group of columns initially requested. As discussed above, a lookup table may be consulted to determine which columns are associated with each component sub-table that is targeted by an AScan operator 706A, 706B, 706C. The AScan operators 706A, 706B, 706C may scan the related component sub-table for the key value K to retrieve data for the relevant columns in the related component sub-table. In this example, AScan B 706B retrieves an EOF value from its component sub-table, which AScan B 706B converts to a null datarow to return to PTScan 704. PTScan can then combine the datarows provided by the AScan operators 706A, 706B, 706C to generate a query result for the select operation 702.

In FIG. 7B, a query plan for a select operation 712 with predicates is shown. The select operation 712 includes a join operation 714, where a key value K, a group of columns, and a predicate that column two (C2) be equal to 2. The join operation 714 references PTScan A 716A and PTScan B 716B, where the predicate for C2 is provided to PTScan A 716A. Similar to PTScan 704 of FIG. 7A, PTScan A 716 and PTScan B 716B reference AScan operators 718A, 718B, 718C. AScan A 718A scans for key value K where C2 is equal to 2 and returns a datarow. AScan B 718B scans for key value K and returns a null datarow, which was converted from an EOF value. AScan C 718C scans for key value K and returns a datarow with values for C5 and C6. PTScan B 716B combines the results from AScan B 718B and AScan C 718C, which is then provided to join operation 714. Join operation 714 joins the results from PTScan A 716A and PTScan B 716B to create a query result for select operation 712.

In FIG. 70, a query plan for an insert operation 722 is shown. The insert operation 722 includes a PTInsert 724, where a key value K and a group of columns with insert values are provided to the PTInsert 724. The PTInsert 724 references insert operators 726A, 726B, which each receive key value K and insert values for the columns in their associated component sub-table. In this example, a third insert operator 726C is avoided because there are no insert values for C5, C6, or C7. Accordingly, a datarow is not inserted into the component sub-table associated with insert operator 726C.

In FIG. 7D, a query plan for a delete operation 732 is shown. The delete operation 732 includes a PTDelete 734, where a key value K is provided to the PTDelete 734. The PTDelete 734 references three delete operators 736A, 736B, 736C, which each delete data rows associated with key value K from their associated component sub-table. In this example, an associated component sub-tables may not contain a datarow if the values of their columns are all null for the key value K.

FIG. 7E is an example workflow for performing an alter operation 742 on a plastic table. The alter operation 742 references plastic table 744 and corresponding component sub-tables 746A, 746B. In this example, component sub-table 746A includes C0 and C1 and is in the process of being replaced by component sub-table 746C, which includes C5 and C6. The completion of the alter operation 742 results in C0 and C1 being dropped from plastic table 744 and C5 and C6 being added to plastic table 744. In some cases, alter operation 742 can be performed while the plastic table 744 is in production. In this case, the component sub-table 746C may be dynamically added to the database and then populated with data from component sub-table 746A. The alter operation 742 may be used to modify a plastic table by removing a column, adding a column, changing a column datatype, etc.

The foregoing disclosure describes a number of example embodiments for providing a flexible data format for a DBMS. In this manner, the embodiments disclosed herein enable the flexible data format by providing component sub-tables that can be combined to form the plastic table. An AScan operator is also provided to efficiently handle the physical storage of null values in the component sub-tables.

1. A system for providing a flexible data format for database management systems (DBMS), the system comprising of:
a database management system executed by a processor to manage a database; and
the processor to:
receive a query command to access a plastic table in the database, wherein the plastic table is a combination of at least two component sub-tables;
execute the query command to join the component sub-tables in the plastic table by:
using an AScan operator to obtain datarows from each of the component sub-tables, wherein the AScan operator converts an end of file (EOF) value to a null datarow that comprises null values; and
joining the datarows obtained from the AScan operator to create query results for the query command.

2. The system of claim 1, wherein a component sub-table of the component sub-tables is associated with a sparse column group that comprises a plurality of sparse columns, and wherein the processor is further to:
receive an insert command to add a new datarow to the plastic table in the database; and
execute the insert command to add the new datarow to the plastic table by executing a PTInsert operator to conditionally add component datarows to the component sub-tables, wherein the component sub-table with the sparse column group is bypassed because each of the plurality of sparse columns is null for the new datarow.

3. The system of claim 1, wherein a component sub-table of the component sub-tables is associated with an original column group that comprises a plurality of columns, and wherein the processor is further to:
create a modified column group that includes a new datatype for one of the plurality of columns;
copy data from the original column group to the modified column group; and
replace the original column group the modified column group for the component sub-table.

4. The system of claim 3, wherein the processor is further to:
update a version number of the plastic table, wherein the version number is associated with a change log that describes the new datatype.

5. The system of claim 3, wherein the plurality of columns is selected for the component sub-table based on a null probability of each of the plurality of columns.

6. The system of claim 3, wherein the plurality of columns is selected to optimize query retrievals for a target application.

7. A method, implemented at least in part by a computing device, for providing a flexible data format for database management systems (DBMS), the method comprising:
receiving a query command to access a plastic table in a database, wherein the plastic table is a combination of at least two component sub-tables, and wherein a component sub-table of the component sub-tables is associated with a plurality of sparse columns that are each selected based on a probability of having a null value;
executing the query command to join the component sub-tables in the plastic table by:
using an AScan operator to obtain datarows from each of the component sub-tables, wherein the AScan operator converts an end of file (EOF) value to a null datarow that comprises null values; and
joining the datarows obtained from the AScan operator to create query results for the query command.

8. The method of claim 7, further comprising:
receiving an insert command to add a new datarow to the plastic table in the database; and
executing the insert command to add the new datarow to the plastic table by executing a PTInsert operator to conditionally add component datarows to the component sub-tables, wherein the component sub-table with the plurality of sparse columns is bypassed because each of the plurality of sparse columns is null for the new datarow.

9. The method of claim 7, wherein a component sub-table of the component sub-tables is associated with an original column group that comprises a plurality of columns, and wherein the method further comprises:
creating a modified column group that includes a new datatype for one of the plurality of columns;
copying data from the original column group to the modified column group; and
replacing the original column group with the modified column group for the component sub-table.

10. The method of claim 9, further comprising:
updating a version number of the plastic table, wherein the version number is associated with a change log that describes the new datatype.

11. The method of claim 9, wherein the plurality of columns is selected to optimize query retrievals for a target application.

12. A non-transitory machine-readable storage medium encoded with instructions executable by a processor for providing a flexible data format for database management systems (DBMS), the machine-readable storage medium comprising instructions to:
receive a query command to access a plastic table in a database, wherein the plastic table is a combination of at least two component sub-tables, and wherein a component sub-table of the component sub-tables is associated with a plurality of sparse columns that are each selected based on a probability of having a null value;
execute the query command to join the component sub-tables in the plastic table by:
using an AScan operator to obtain datarows from each of the component sub-tables, wherein the AScan operator converts an end of file (EOF) value to a null datarow that comprises null values; and
joining the datarows obtained from the AScan operator to create query results for the query command.

13. The machine-readable storage medium of claim 12, further comprising instructions to:
receive an insert command to add a new datarow to the plastic table in the database; and
execute the insert command to add the new datarow to the plastic table by executing a PTInsert operator to conditionally add component datarows to the component sub-tables, wherein the component sub-table with the plurality of sparse columns is bypassed because each of the plurality of sparse columns is null for the new datarow.

14. The machine-readable storage medium of claim 12, wherein a component sub-table of the component sub-tables is associated with an original column group that comprises a plurality of columns, and wherein the machine-readable storage medium further comprises instructions to:
create a modified column group that includes a new datatype for one of the plurality of columns;
copy data from the original column group to the modified column group; and
replace the original column group with the modified column group for the component sub-table.

15. The machine-readable storage medium of claim 14, further comprising instructions to:
update a version number of the plastic table, wherein the version number is associated with a change log that describes the new datatype.
